(19) United States
(12) Patent Application Publication
(10) Pub. No.: US 2016/0117706 A1
(43) Pub. Date: Apr. 28, 2016

(54) DEVICE, METHOD AND SYSTEM OF TESTING FINANCIAL DERIVATIVE INSTRUMENTS

(71) Applicant: SUPER DERIVATIVES, INC., NEW YORK, NY (US)

(72) Inventor: David Gershon, Tel Aviv (IL)

(21) Appl. No.: 14/834,572

(22) Filed: Aug. 25, 2015

Related U.S. Application Data
(63) Continuation of application No. 13/878,565, filed on Jul. 8, 2013, now abandoned.
(60) Provisional application No. 61/391,648, filed on Oct. 10, 2010.

(51) Int. Cl. G06Q 30/02; G06Q 40/04

(52) U.S. Cl. CPC G06Q 30/0206; G06Q 40/04

(57) ABSTRACT

Devices, systems and methods of testing financial-derivative instruments. For example, a method may include receiving input information defining a tested financial derivative instrument and one or more testing parameters defining at least a back-testing period; simulating results of a plurality of simulation scenarios corresponding to a plurality of points of time within the back-testing period, each scenario including a modification of the tested financial derivative instrument with respect to a point of time within the back-testing period; and providing an output, which is based on the results of the plurality scenarios.

### CROSS REFERENCE

This application claims the benefit of and priority from U.S. Provisional Patent application 61/391,648, entitled “Method and system of back-testing financial instruments”, filed Oct. 10, 2010, the entire disclosure of which is incorporated herein by reference.

### FIELD

The disclosure relates generally to financial instruments and, more specifically, to methods and systems for simulating and/or analyzing financial instruments.

### BACKGROUND

Pricing financial instruments is a complex art requiring substantial expertise and experience. Trading financial instruments, such as options, involves a sophisticated process of pricing typically performed by a trader.

The term “option” in the context of the present application is broadly defined as any financial instrument having option-like properties, e.g., any financial derivative including an option or an option-like component. This category of financial instruments may include any type of option or option-like financial instrument, relating to some underlying asset. Assets as used in this application include anything of value; tangible or non-tangible, financial or non-financial, for example, stocks; currencies; commodities, e.g., oil, metals, or sugar; interest rates; forward-rate agreements (FRA); swaps; futures; bonds; weather, e.g. the temperature at a certain area; electricity; gas emission; credit; mortgages; indices; and the like. For example, as used herein, options range from a simple Vanilla option on a single stock and up to complex convertible bonds whose convertibility depends on some key, e.g., the weather.

The term “Exchange” in the context of the present application relates to any one or more exchanges throughout the world, and includes all assets/securities, which may be traded in these exchanges. The terms “submit a price to the exchange”, “submit a quote to the exchange”, and the like generally refer to actions that a trader may perform to submit a bid and/or offer prices for trading in the exchange. The price may be transferred from the trader to the exchange, for example, by a broker, by online trading, on a special communication network, through a clearing house system, and/or using in any other desired system and/or method.

The price of an asset for immediate, e.g., 1 or 2 business days, delivery is called the spot price. For an asset sold in an option contract, the strike price is the agreed upon price at which the deal is executed if the option is exercised. For example, a stock option involves buying or selling a stock. The spot price is the current stock price on the exchange in which is the stock is traded. The strike price is the agreed upon price to buy/sell the stock if the option is exercised.

To facilitate trading of options and other financial instruments, a market maker suggests a bid price and offer price (also called ask price) for a certain option. The bid price is the price at which the market maker is willing to purchase the option and the offer price is the price at which the market maker is willing to sell the option. As a market practice, a first trader interested in a certain option may ask a second trader for a quote, e.g., without indicating whether the first trader is interested to buy or to sell the option. The second trader quotes both the bid and offer prices, not knowing whether the first trader is interested in selling or buying the option. The market maker may earn a margin by buying options at a first price and selling them at a second price, e.g., higher than the first price. The difference between the offer and bid prices is referred to as bid-offer spread.

A call option is the right to buy an asset at a certain price (“the strike”) at a certain time, e.g., on a certain date. A put option is the right to sell an asset at a strike price at a certain time, e.g., on a certain date. Every option has an expiration time in which the option ceases to exist. Prior to the option expiration time, the holder of the option may determine whether or not to exercise the option, depending on the prevailing spot price for the underlying asset. If the spot price at expiration is lower than the strike price, the holder will choose not to exercise the call option and lose only the cost of the option itself. However, if the strike is lower than the spot, the holder of the call option will exercise the right to buy the underlying asset at the strike price making a profit equal to the difference between the spot and the strike prices. The cost of the option is also referred to as the premium.

A forward rate is defined as the predetermined rate or price of an asset, at which an agreed upon future transaction will take place. The forward rate may be calculated based on a current rate of the asset, a current interest rate prevailing in the market, expected dividends (for stocks), cost of carry (for commodities), and/or other parameters depending on the underlying asset of the option.

An at-the-money forward option (ATM) is an option whose strike is equal to the forward rate of the asset. In some fields, the at-the-money forward options are generically referred to as at-the-money options, as is the common terminology in the commodities and interest rates options. The at the money equity options are actually the at the money spot, i.e. where the strike is the current spot rate or price.

An in-the-money call option is a call option whose strike is below the forward rate of the underlying asset, and an in the-money put option is a put option whose strike is above the forward rate of the underlying asset. An out-of-the-money call option is a call option whose strike is above the forward rate of the underlying asset, and an out-of-the-money put option is a put option whose strike is below the forward rate of the underlying asset.

An exotic option, in the context of this application, is a generic name referring to any type of option other than a standard Vanilla option. While certain types of exotic options have been extensively and frequently traded over the years, and are still traded today, other types of exotic options had been used in the past but are no longer in use today. Currently, the most common exotic options include “barrier” options, “digital” options, “binary” options, “partial barrier” options (also known as “window” options), “average” options, “compound” options and “quanto” options. Some exotic options can be described as a complex version of the standard (Vanilla) option. For example, barrier options are exotic options where the payoff depends on whether the underlying asset's price reaches a certain level, hereinafter referred to as “trigger”, during a certain period of time. The “pay off” of an option is defined as the cash realized by the holder of the option upon its expiration. There are generally two types of barrier options, namely, a knock-out option and a knock-in option. A knock-out option is an option that terminates if and when the spot reaches the trigger. A knock-in option comes into existence only when the underlying asset's price reaches the trigger. It is noted that the combined effect of a knock-out option with strike K and trigger B and a knock-in option with strike K and trigger B, both having the same expiration, is equivalent to a corresponding Vanilla option with strike K. Thus, knock-in options can be priced by pricing corresponding knock-out and vanilla options. Similarly, a one-touch option can be decomposed into two knock-in call options and two knock-in put options, a double no-touch option can be decomposed into two double knock-out options, and so on. It is appreciated that there are many other types of exotic options known in the art.

Certain types of options, e.g., Vanilla options, are commonly categorized as either European or American. A European option can be exercised only upon its expiration. An American option can be exercised at any time after purchase and before expiration. For example, an American Vanilla option has all the properties of the Vanilla option type described above, with the additional property that the owner can exercise the option at any time up to and including the option's expiration date. As is known in the art, the right to exercise an American option prior to expiration makes American options more expensive than corresponding European options.

Generally in this application, the term “Vanilla” refers to a European style Vanilla option. European Vanilla options are the most commonly traded options; they are typically traded over the counter (OTC). American Vanilla options are more popular in the exchanges and, in general, are more difficult to price.

### SUMMARY

Some demonstrative embodiments include devices, systems and/or methods of testing, analyzing and/or processing financial instruments.

In some demonstrative embodiments, back-testing of a financial instrument, e.g., a trade strategy, may be useful in viewing, simulating, modeling and/or analyzing the performance of the financial instrument over a defined period in the past. In one example, a sales person, or any other suitable user, may use the back testing in order to show a customer how a suggested trade strategy would have resulted in the past and, therefore, convince the customer of a potential return of the trade strategy.

Some demonstrative embodiments may be utilized for back-testing financial instruments, which may be relatively “complex” and/or which may be difficult, or even impossible, for straightforward analysis and/or understanding. For example, a complex instrument may include an option, or a combination of options and deposited amount of money or bonds or swaps, where the payouts or coupons depend on various conditions during the life of the structure. Usually, it is very hard to envision the payout and directly link the payout/coupon to future scenarios and, therefore, a retrospective analysis may provide significant indication if the structure is likely to generate the desired outcome. The complex instrument may include, for example, some of the known financial products in the market, many of them are callable structures which one side can terminate at predetermined dates or periods. Such structure swaps may include “snowball”, “range accrual”, Power reverse dual currency (PRDC), target redemption products (TARN), clique, autocallable, and the like.

It may be very difficult, or even impossible, to analyze and/or evaluate some complex financial instruments, e.g., on a historical basis without, for example, a very powerful computing system and/or historical databases. In some embodiments, the calculation may be performed faster, for example, by pre-calculating a significant amount of the calculations in advance.

Historical back testing may provide a powerful tool by enabling simulation of financial scenarios. Selecting the back-testing period may determine the variety of scenarios that are taken into account. For example, if one examines a back-testing period of interest rates structure product of the last 20 years it may cover so many possible scenarios.

In some demonstrative embodiments, the back-testing of a complex financial instrument may provide an efficient tool, or even the only tool, which may allow analyzing and/or evaluating the complex financial instrument. In one demonstrative embodiment, back-testing of a the complex instrument may be useful in viewing, simulating, modeling and/or analyzing the performance of the complex instrument over a defined period in the past, for example, in order to evaluate the complex instrument based on how the complex instrument would have resulted in the past.

In some demonstrative embodiments, a computer-based method of testing a financial derivative instrument may include receiving, by a computing device, input information defining a tested financial derivative instrument and one or more testing parameters defining at least a back-testing period; simulating, by the computing device, results of a plurality of simulation scenarios corresponding to a plurality of points of time within the back-testing period, each scenario including a modification of the tested financial derivative instrument with respect to a point of time within the back-testing period; and providing, by the computing device an output, which is based on the results of the plurality scenarios.

In some demonstrative embodiments, a simulation scenario of the plurality of simulation scenarios, which corresponds to a point of time of the plurality of points of time, may include a simulation of a modified replica of the tested financial derivative instrument with respect to the point of time.

In some demonstrative embodiments, the plurality of points of time within the back-testing period may include a plurality of historic points of time preceding a current time of testing the tested financial derivative instrument. For example, simulating the results of the plurality of simulation scenarios may include determining the results of the plurality of simulation scenarios based on historical market data corresponding to the plurality of historic points of time.

In some demonstrative embodiments, the input information defines a testing scheme, and simulating the results of the plurality of simulation scenarios may include defining the plurality of simulation scenarios according to the testing scheme.

In some demonstrative embodiments, the testing scheme may include a buy and hold total payoff scheme. For example, simulating the results of the plurality of simulation scenarios may include determining a total payout of a plurality of simulated financial derivative instruments, similar to the tested financial derivative instrument and having an expiration date at the plurality of points of time within the testing period.

In some demonstrative embodiments, the testing scheme may include a profit/loss from inception scheme. For example, simulating the results of the plurality of simulation scenarios may include determining a total profit or loss of a plurality of simulated financial derivative instruments, similar to the tested financial derivative instrument and having an inception date at the plurality of points of time within the testing period and an expiration date at a current date.

In some demonstrative embodiments, the testing scheme may include a profit/loss during a time period of a predefined length. For example, simulating the results of the plurality of simulation scenarios may include determining a total profit or loss of a plurality of simulated financial derivative instruments, similar to the tested financial derivative instrument, during a respective plurality of time periods, each beginning at one of the plurality of points of time within the testing period and having the predefined length.

In some demonstrative embodiments, simulating the results of the plurality of simulation scenarios may include simulating the results of the plurality of simulation scenarios based on one or more approximated evaluation parameters corresponding to the plurality of points of time within the testing period.

In some demonstrative embodiments, simulating the results of the plurality of simulation scenarios may include simulating the results of the plurality of simulation scenarios based on pre-calculated information including at least one of pre-calculated volatility surfaces and pre-calculated yield curves corresponding to one or more of the plurality of points of time within the back-testing period.

In some demonstrative embodiments, the method may include forward-testing the financial derivative instrument to predict a future performance of the financial derivative instrument based on the results of the plurality scenarios.

In some demonstrative embodiments, the points of time may relate, for example, to at least one of an expiration date of the simulated financial derivative instrument and an inception date of the simulated financial derivative instrument.

In some demonstrative embodiments, a system may include a memory having stored thereon instructions; and a processor to execute the instructions resulting in a testing module. The testing module may be configured to receive input information defining a tested financial derivative instrument and one or more testing parameters defining at least a back-testing period; to simulate results of a plurality of simulation scenarios corresponding to a plurality of points of time within the back-testing period, each scenario including a modification of the tested financial derivative instrument with respect to a point of time within the back-testing period; and to provide an output, which is based on the results of the plurality scenarios.

Some demonstrative embodiments may include a machine-readable medium having stored thereon instructions, which when executed by a machine result in receiving input information defining a tested financial derivative instrument and one or more testing parameters defining at least a testing period; simulating results of a plurality of simulation scenarios corresponding to a plurality of points of time within the testing period, each scenario including a modification of the tested financial derivative instrument with respect to a point of time within the testing period; and providing an output, which is based on the results of the plurality scenarios.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic illustration of a system, in accordance with some demonstrative embodiments.

FIG. 2A is a screenshot illustration of an interface for defining a foreign-exchange instrument to be tested; and FIG. 2B depicts a screenshot illustration of back-testing results of back-testing the tested instrument of FIG. 2A according to a “Buy and hold total payout” back-testing scheme, in accordance with some demonstrative embodiments.

FIG. 3A is a screenshot illustration of an interface for defining an interest-rate instrument to be tested; and FIG. 3B depicts a screenshot illustration of back-testing results of back-testing the tested instrument of FIG. 3A according to the “Buy and hold total payout” back-testing scheme, in accordance with some demonstrative embodiments.

FIGS. 4A-4J are a series of screenshot illustrations of interface components for back-testing of a financial instrument, in accordance with some demonstrative embodiments.

FIG. 5 is a schematic flow-chart illustration of a method of testing a financial instrument, in accordance with some demonstrative embodiments.

FIG. 6 is schematic illustration of an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Some embodiments may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a cellular telephone, a wireless telephone, a Personal Communication Systems (PCS) device, a PDA device which incorporates a wireless communication device, a device having one or more internal antennas and/or external antennas, a wired or wireless handheld device (e.g., BlackBerry, Palm Treo), a Wireless Application Protocol (WAP) device, or the like.

Some demonstrative embodiments are described herein in the context of testing a financial instrument, e.g., a Foreign Exchange (FX) or Exchange-rate (ER) option, options on Interest Rate (IR) futures and/or options on commodities. It should be appreciated, however, that other embodiments may include testing any other suitable financial instruments and/or markets, and the embodiments are not limited to stock options. One skilled in the art may apply the embodiments to other options and/or option-like financial instruments, e.g., any suitable options on any suitable asset instruments and/or options on non-asset instruments, such as options on the weather and/or the temperature, and the like, with variation as may be necessary to adapt for factors unique to a given financial instrument.

The phrase “financial derivative instrument” (also referred to herein as “derivative instrument”, “financial instrument”, “trade structure” or “trade strategy”) may refer to any one or more suitable derivative instruments, e.g., forwards, swaps, futures, exchange options, OTC options, and the like, which derive their value from the value and characteristics of one or more underlying assets of any suitable “asset class”, e.g., FX, Interest Rate, Equity, Commodities, Credit, weather, energy, real estate, mortgages, and the like; and/or may involve more than one asset class, e.g., cross-asset, multi asset, and the like. The phrase “financial instrument” may also refer to any suitable combination or structure of one or more financial instruments.

The phrase “back testing” may refer to analyzing, simulating, modeling, and/or evaluating a financial instrument based on historical trading data, for example, in order to analyze, evaluate, model and/or simulate performance of the financial instrument. In some embodiments the back testing may refer to a defined back-testing period of time in the past, e.g., relative to a current date. In one example, the back testing may refer to a back-testing period beginning at a first date, which is a defined period, e.g., three months, one year, two years, five years, and the like, prior to the current date, and ending at the current date. In another example, the back testing may refer to a period beginning at a first date. The first date may include an absolute date, e.g., defined by a user; or a relative date defined, e.g., by a user, relative to the current date. For example, the first date may be a defined period, e.g., three months, one year, two years, five years, and the like, prior to the current date and ending at a second date. The second date may include an absolute date, or a relative date, which may be defined relative to the first date, e.g., a date which is a defined period, e.g., three months, one year, two years, five years, and the like, after the first date; or relative to the current date e.g., a date which is a defined period, e.g., three months, one year, two years, five years, and the like, prior to the current date.

In some demonstrative embodiments, back-testing of a financial instrument, e.g., a trade strategy, may be useful in viewing, simulating, modeling and/or analyzing the performance of the financial instrument over a defined period in the past. In one example, a sales person, or any other suitable user, may use the back testing in order to show a customer how a suggested trade strategy would have resulted in the past and, therefore, convince the customer of a potential return of the trade strategy.

Some demonstrative embodiments may be utilized for testing financial instruments, which may be relatively “complex” and/or which may be difficult, or even impossible, for straightforward analysis and/or understanding. For example, a complex instrument may include an option, or a combination of options and deposited amount of money or bonds or swaps, where the payouts or coupons depend on various conditions during the life of the structure. Usually, it is very hard to envision the payout and directly link the payout/coupon to future scenarios and, therefore, a retrospective analysis may provide significant indication if the structure is likely to generate the desired outcome. The complex instrument may include, for example, some of the known financial products in the market, many of them are callable structures which one side can terminate at predetermined dates or periods. Such structure swaps may include “snowball”, “range accrual”, Power reverse dual currency (PRDC), target redemption products (TARN), clique, autocallable, and the like.

It may be very difficult, or even impossible, to analyze and/or evaluate some complex financial instruments on a historical basis without, for example, a very powerful computing system and/or historical databases. In some embodiments, the calculation may be performed faster, for example, by pre-calculating a significant amount of the calculations in advance, e.g., as described herein.

Historical back testing may provide a powerful tool by enabling simulation of financial scenarios. Selecting the back-testing period may determine the variety of scenarios that are taken into account. For example, if one examines a back-testing period of interest rates structure product of the last 20 years it may cover so many possible scenarios.

In some demonstrative embodiments, the back-testing of a complex financial instrument, e.g., as described below, may provide an efficient tool, or even the only tool, which may allow to analyze and/or evaluate the complex financial instrument. In one demonstrative embodiment, back-testing of a the complex instrument may be useful in viewing, simulating, modeling and/or analyzing the performance of the complex instrument over a defined period in the past, for example, in order to evaluate the complex instrument based on how the complex instrument would have resulted in the past.

In some demonstrative embodiments, forward-testing may be performed, for example, based on the results of the back-testing, e.g., in order to model, simulate and/r analyze a predicted future performance of the back tested financial instrument, e.g., as described below.

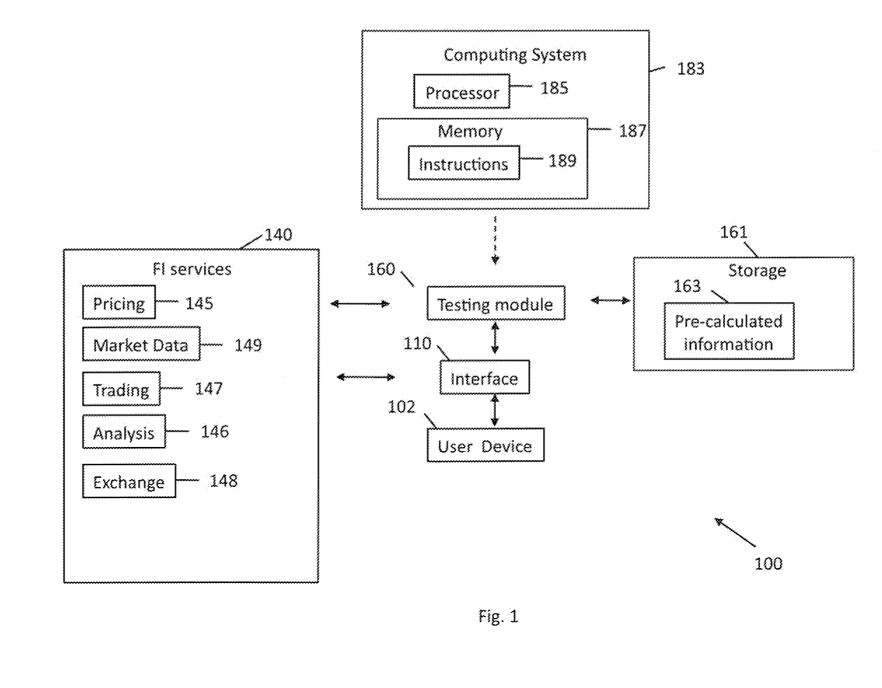

Reference is now made to FIG. 1, which schematically illustrates a block diagram of a system 100, in accordance with some demonstrative embodiments.

In some demonstrative embodiments, system 100 may include a testing module 160 to test one or more financial instruments, e.g., as described below.

In some demonstrative embodiments, module 160 may be capable of back testing any suitable financial instrument on any suitable underlying asset, e.g. currencies, interest rates, commodities, equity, energy, credit, weather, and the like.

In some demonstrative embodiments, system 100 includes one or more user stations or devices 102, for example, a PC, a laptop computer, a PDA device, and/or a terminal, to allow one or more users to simulate and/or analyze the one or more financial instruments using module 160, e.g., as described herein.

In some demonstrative embodiments, devices 102 may be implemented using suitable hardware components and/or software components, for example, processors, controllers, memory units, storage units, input units, output units, communication units, operating systems, applications, or the like.

The user of device 102 may include, for example, a trader, a business analyst, a corporate structuring manager, a salesperson, a risk manager, a front office manager, a back office, a middle office, a system administrator, and the like.

In some demonstrative embodiments, system 100 may also include an interface 110 to interface between users 102 and one or more elements of system 100, e.g., module 160. Interface 110 may optionally interface between users 102 and one or more Financial-Instrument (FI) systems and/or services 140. Services 140 may include, for example, a suitable pricing module 145 capable of pricing one or more financial instruments according to any suitable pricing method and/or algorithm, one or more market data services 149, one or more trading systems 147, one or more exchange connectivity systems 148, one or more analysis services 146 and/or one or more other suitable FI-related services, systems and/or platforms.

In some demonstrative embodiments, module 160 may be capable of communicating, directly or indirectly, e.g., via interface 110 and/or any other interface, with one or more suitable modules of system 100, for example, one or more of FI systems 140, a database, a storage, an archive, an HTTP service, an FTP service, an application, and/or any suitable module capable of providing, e.g., automatically, input to module 160 and/or receiving output generated by module 160, e.g., as described herein.

In some demonstrative embodiments, module 160 may be implemented as part of FI systems/services 140, e.g., as part of, or in association with, pricing module 145, as part of device 102 and/or as part of any other suitable system or module, e.g., as part of any suitable server, or as a dedicated server.

In some demonstrative embodiments, module 160 may include a local or remote application executed by any suitable computing system 183. For example, computing system 183 may include a suitable memory 187 having stored-thereon application instructions 189, and a suitable processor 185 to execute instructions 189 resulting in module 160.

In some demonstrative embodiments, computing system 183 may include or may be part of a server to provide the functionality of module 160 to users 102. In other embodiments, computing system 183 may be implemented as part of user station 102. For example, instructions 189 may be downloaded and/or received by users 102 from another computing system, such that module 160 may be locally executed by users 102. For example, instructions 189 may be received and stored, e.g., temporarily, in a memory or any suitable short-term memory or buffer of user device 102, e.g., prior to being executed by a processor of user device 102. In other embodiments, computing system 183 may include any other suitable computing arrangement, server and/or scheme.

In some demonstrative embodiments, computing system 183 may also execute one or more of FI systems/services 140. In other embodiments, module 160 may be implemented separately from one or more of FI systems/services 140.

In some demonstrative embodiments, interface 110 may be implemented as part of module 160, FI systems/services 140 and/or as part of any other suitable system or module, e.g., as part of any suitable server.

In some demonstrative embodiments, interface 110 may be associated with and/or included as part of devices 102. In one example, interface 110 may be implemented, for example, as middleware, as part of any suitable application, and/or as part of a server. Interface 110 may be implemented using any suitable hardware components and/or software components, for example, processors, controllers, memory units, storage units, input units, output units, communication units, operating systems, applications. In some demonstrative embodiments, interface 110 may include, or may be part of a Web-based pricing application interface, a web-site, a web-page, a stand-alone application, a plug-in, an ActiveX control, a rich content component (e.g., a Flash or Shockwave component), or the like.

In some demonstrative embodiments, interface 110 may also interface between users 102 and one or more of FI systems and/or services 140.

In some demonstrative embodiments, interface 110 may be configured to allow users 102 to enter commands; to define a financial instrument to be back-tested by module 160; to define and/or structure a trade corresponding to the financial instrument; to transact the trade; and/or to perform any other suitable operation. For example, interface 110 may include or may be associated with a suitable Graphical User Interface (GUI).

In some demonstrative embodiments, interface 110 and module 160 may be implemented as part of an application server to process user information, e.g., including details of a defined trade structure to be analyzed, which may be received from user 102, as well as trade information, which may be received, for example, from market data service 149. System 100 may also include storage 161, e.g., a database, for storing the user information and/or the trade information.

The user information may be received from user 102, for example, via a communication network, for example, the Internet, e.g., using a direct telephone connection or a Secure Socket Layer (SSL) connection, a Local Area Network (LAN), or via any other communication network known in the art. Module 160 may communicate back-results of a back-testing analysis corresponding to the defined option to user 102 via interface 110, e.g., in a format convenient for presentation to user 102.

In some demonstrative embodiments, module 160 may receive information defining a financial instrument to be tested (“the tested instrument”) and one or more back-testing parameters defining the back-testing analysis. The tested instrument and/or the back-testing parameters may be defined, for example, by user 102, e.g., using interface 110.

In some demonstrative embodiments, the back-testing parameters may define, for example, at least one of a back-testing scheme to be used for the back testing, a beginning date of the back-testing, a period of the back-testing and/or an end-date of the back-testing, e.g., as described herein.

Some demonstrative embodiments are described herein with relation to various demonstrative back-testing schemes, for example, a “buy and hold total payoff” back-testing schemes, a “profit/loss from inception” back-testing schemes, and/or a “profit/loss after time X” back-testing schemes, e.g., as described below. However, other embodiments may be implemented with respect to any other suitable scheme, type and/or method of back-testing.

In some demonstrative embodiments, module 160 may perform the back-testing with respect to the tested instrument and a back-testing period, which may be defined, for example, by user 102. The back testing period may include a period of time in the past relative to a current date. In one example, the back testing period may begin at a first date, and end at a second date. The first and second dates may be absolute dates and/or relative dates, e.g., dates defined relative to the current date and/or the first date. For example, the first date may be a defined period, e.g., three months, one year, two years, five years, and the like, prior to the current date; an the second date may include the current date. In another example, the first date may be a defined period, e.g., three months, one year, two years, five years, and the like, prior to the current date; the second date may be defined relative to the first date, e.g., a date which is a defined period, e.g., three months, one year, two years, five years, and the like, after the first date; or relative to the current date e.g., a date which is a defined period, e.g., three months, one year, two years, five years, and the like, prior to the current date.

In some demonstrative embodiments, module 160 may provide back-testing result information corresponding to the tested instrument (“the back-testing results”). The back-testing results may be utilized to evaluate the tested instrument, for example, by demonstrating the effectiveness of the tested instrument over a series of historical dates using real, e.g., historical data. The back-testing results may show how the tested instrument would have performed in past markets if it had actually been entered into in the past. Although past results do not necessarily indicate future results, the back-testing results may be useful for analysis and/or prediction. The back-testing results may help a user better understand the tested instrument as it encountered real-world conditions in the past.

In some demonstrative embodiments, module 160 may forward-test the tested financial instrument, for example, based on the results of the back-testing, e.g., in order to model, simulate and/r analyze a predicted future performance of the back tested financial instrument.

In some demonstrative embodiments, module 160 may determine, based on the back-testing results, one or more parameters relating to pricing the tested financial instrument. For example, module 160 may determine one or more volatility-related parameters based on the back-testing results. Module 160 may forward-test the tested financial instrument by simulating one or more future scenarios using the determined one or more volatility-related parameters. Additionally or alternatively, module 160 may identify one or more trends in the performance of the tested financial instrument, based on the back-testing results. Module 160 may forward-test the tested financial instrument to predict the performance of the tested financial instrument according to the identified trends. For example, module 160 may identify, based on the back-testing results, an increase in the payoff of the, throughout time, e.g., during the last three months prior to the current date. Accordingly, module 160 may forward-test the financial instrument by applying the identified payoff increase to future dates.

In some demonstrative embodiments, module 160 may generate the back-testing results, for example, by simulating results of a plurality of simulation scenarios corresponding to a plurality of points of time within a defined testing period.

In some demonstrative embodiments, a simulated scenario may include a modification of the tested financial instrument with respect to a point of time within the testing period. For example, module 160 may generate the back-testing results, for example, by simulating a series of, e.g., modified replicas of the tested financial instrument, each of which corresponds to, e.g., begins, expires and/or is traded on, a different point of time, e.g., date, for example, at subsequent business dates, within a defined back-testing period, e.g., as described below.

In some demonstrative embodiments, module 160 may determine a back-testing result, e.g., payoff and/or any other predefined back-testing result, using relevant market data corresponding to the tested instrument, e.g., end-of-day market data, which may be stored, for example, on storage 161. For path dependent instruments, e.g., a knock in or knock out instrument, module 160 may also take into account data, e.g., path-dependent data, over the lifetime of the tested instrument, e.g., to determine whether or not the tested instrument would have been knocked in or out, and the like.

In some demonstrative embodiments, module 160 may generate back-testing results relating to one or more dates during the back-testing period. In one example, module 160 may generate the back-testing results relating to each day during the back-testing period. In other embodiments, may generate the back-testing results at any other resolution, for example, at evenly spaced dates, e.g., for every week, month, year, and the like, within the back-testing period, or at any other suitable dates.

In one example, user 102 may define the back-testing period to include a period of three months prior to the current date, and module 160 may generate the back-testing output values, e.g., including a payoff of the tested instrument, relating to each day within the period beginning three months prior to the current date and ending at the current date.

In some demonstrative embodiments, the tested instrument may be defined by defining a trade-duration, e.g., given as tenor or using specific dates, one or more strikes, e.g., relative or numeric, one or more rates, e.g., relative or numeric, and/or any other suitable information required for defining the tested instrument.

In some demonstrative embodiments, module 160 may generate the back-testing output values including payoff values, e.g., as a payoff percentage, as a payoff amount and/or in any other form. The payout percentage may be defined as a ratio between the cash payout and the notional value, e.g., for a single instrument. The payout percentage may be defined as a ratio between the cash payout of all legs of the tested instrument and the notional value of a first leg, e.g., if the tested instrument includes a portfolio.

In some demonstrative embodiments, the back-testing of some financial instruments may require relatively complex and/or time-consuming computations.

In some demonstrative embodiments, values of one or more evaluation parameters may be required, for example, in order to back-test the tested instrument, e.g., to evaluate the payoff of the tested instruments. For example, the values of the evaluation parameters corresponding to different dates, e.g., dates prior to or within the back-testing period, may be required. In one example, relative strikes and/or Break Even (BE) rates may be required, for example, in order to back-test an IR instrument, e.g., to evaluate the payoff of IR instruments.

In some embodiments, module 160 may calculate an approximation of the evaluation parameters relating to the tested instrument, e.g., as described below.

One embodiment may be implemented, for example, if the tested instrument includes a simple-spot starting swap. According to this embodiment, the BE rate of the tested instrument for a certain date may include the historical market data rate corresponding to the financial instrument.

Another embodiment may be implemented, for example, if evaluation of the tested instrument requires a rate corresponding to forward (fwd) starting swaps and/or ATM strikes. According to this embodiment, the rate may be approximated, for example, as follows:

F=n*((dfₛₜₐᵣₜ/df_{end})̂(1/(n*y))−1) (1)

wherein F denotes the fwd swap rate approximated at start of trade, i.e., the ATM strike; wherein n denotes the number of fixed leg coupons per year; wherein y denotes a number of years in underlying swap; wherein dfstart denotes a Discount Factor (DF) of the start date of the underlying swap (for swaptions and fwd start date for swaps); wherein dfend denotes the DF of the maturity date of the underlying swap (for swaptions and end date for swaps), and wherein interest rates are expressed in absolute format, i.e., a 4% interest rate is expressed as 0.04.

Additionally or alternatively, the Libor forward rate corresponding to a period x may be approximated, for example, as follows:

Libor forward rate for period x=(dfₛₜₐᵣₜ/df_{end}−1)/(dcₓ) (2)

wherein dfₛₜₐᵣₜ denotes a start date of Libor; wherein df_{end} denotes end date of Libor; dcₓ denotes a day-count fraction for period x; and wherein interest rates are expressed in absolute format.

Another embodiment may be implemented, for example, if evaluation of the tested instrument requires a Constant-Maturity-Swap (CMS) forward fwd rate. According to this embodiment, the CMS fwd rate may be approximated, for example, as follows:

CMS forward rate=[forward BE swap rate starting at CMS coupon start date (or end date if arrears)]*(convexity adjustment) (3)

wherein the convexity adjustment may include any suitable adjustment value, for example, one.

Another embodiment may be implemented, for example, if evaluation of the tested instrument requires the BE rate. According to this embodiment, the BE rate may be approximated, for example, as follows:

B.E. swap rate=(Σ_{I=1 to n} fwdᵢ*dfᵢ*dcᵢ)/(Σ_{j=1 to m} dfⱼ*dcⱼ) (4)

wherein n denotes the number of floating leg coupons; m denotes the number of fixed leg coupons; dcₓ denotes the day-count fraction for period x; dfₓ denotes the discount factor for period x payment date; and wherein fwdₓ denotes the forward rate for period x.

Another embodiment may be implemented, for example, if evaluation of the tested instrument requires a Cap/floor ATM strike. According to this embodiment, the Cap/floor ATM strike may be approximated, for example, as follows:

Cap/floor ATM strike=(Σ_{I=1 to n}fwdᵢ*dcᵢ*dfᵢ)/(dcᵢ*dfᵢ) (5)

wherein N denotes a number of caplets.

Another embodiment may be implemented, for example, if evaluation of the tested instrument requires a CMS FWD cap utilizing a swap forward rate, denoted Fwdᵢ. According to this embodiment, the rate Fwdᵢ, may be approximated, for example, as follows:

Fwdᵢ=cmsfwdᵢ (6)

and for libor cap:

Fwdᵢ=libor fwdᵢ (7)

Another embodiment may be implemented, for example, if evaluation of the tested instrument requires a CMS spread rate. According to this embodiment, the CMS spread rate may be approximated, for example, by calculating the CMS spread, e.g., according to Equations 6 and/or 7, for each CMS period. For example CMS 10 Y vs. CMS 2 Y, calculation of each swap fwd rate may be calculated according to Equations 6 and/or 7. The CMS spread fwd rate/CMS spread option ATM strike may be the difference in rates between a first calculated rate, denoted cmsfwdᵢ(long term cms), corresponding to a long term cms, and a second calculated rate, denoted cmsfwdᵢ(short term cms), corresponding to a short term CMS, e.g., as follows:

Fwdᵢ=cmsfwdᵢ(long term cms)−cmsfwdᵢ(short term cms) (8)

In some demonstrative embodiments, the calculation of some of evaluation parameters may require relatively complex and/or time-consuming computations. For example, the calculation of some of the discount factors discussed above may require the computation of volatility surfaces, yield curves, implied dividends, and the like, which may be relatively complex and/or time-consuming.

In some demonstrative embodiments, module 160 may utilize pre-calculated information 163, which may be stored, for example, in storage 161. The use of pre-calculated information 163 may improve report run time and/or may allow module 160 to perform the back-testing of the tested instrument in real-time.

In some embodiments, module 160 may pre-calculate volatility surfaces corresponding to different historical dates, and based on the calculated volatility surfaces, module 160 may determine volatility-related parameters corresponding to the historical date. The volatility surface corresponding to a date may include, for example, the implied volatility corresponding to the date, for example, as a function of both strike price and time to maturity. For example, pre-calculated information 163 may include pre-calculated volatility surfaces corresponding to a plurality of dates, e.g., each day, within a predefined time period, e.g., three months, one year, three years, five years, and the like, previous to the current date. For example, on Aug. 20, 2010, pre-calculated information 163 may include the pre-calculated volatility surfaces corresponding to each day between Aug. 20, 2005 and Aug. 20, 2010. Accordingly, module 160 may perform the back-testing computations utilizing the required pre-calculated volatility surfaces, e.g., instead of re-building the volatility surfaces each time for each date.

In some embodiments, module 160 may pre-calculate Yield Curves corresponding to different historical dates, and based on the calculated yield curves, module 160 may determine the discount factors corresponding to the historical date. For example, pre-calculated information 163 may include pre-calculated discount factors corresponding to a plurality of dates, e.g., each day, within a predefined time period, e.g., three months, one year, three years, five years, and the like, previous to the current date. For example, on Aug. 20, 2010, pre-calculated information 163 may include the pre-calculated discount factors corresponding to each day between Aug. 20, 2005 and Aug. 20, 2010. Accordingly, module 160 may perform the back-testing computations utilizing the required pre-calculated discount factors, e.g., instead of re-building the Yield Curve each time for each date and deducing the discount factors.

In some demonstrative embodiments, module 160 may pre-calculate and/or update information 163 at any suitable frequency, e.g., on a daily basis, and the like.

In some demonstrative embodiments, module 160 may generate back-testing output of back-testing the tested instrument according to a “Buy and hold total payout” scheme. According to this scheme, module 160 may evaluate a total payout (or pay-off), e.g., including any intermediary events, of the tested instrument over a range of dates within the back-testing period. For example, at successive Start dates with rolling expiry.

In some demonstrative embodiments, module 160 may calculate the payoff of the tested instrument, for example, using as the trade date of the instrument one or more days, e.g., everyday, from the Start Date to the End date of the back-testing period; and while keeping the time to maturity of the tested instrument, e.g., in terms of days to expiration, constant.

According to the “Buy and hold total payout” scheme, module 160 may assume that the tested instrument matures on each date in the testing period.

In some demonstrative embodiments, the “Buy and hold total payout” scheme may be utilized, e.g., as part in marketing documents with respect to structured financial products. The back-testing results according to the “Buy and hold total payout” may give a clear and/or undisputed view of how the structured product would have performed historically.

In some demonstrative embodiments, module 160 may evaluate the payoff of the tested instrument based, for example, on official closing levels, e.g., daily historical closing levels of prices of the underlying asset of the tested instrument. Module 160 may evaluate the payoff of the tested instrument based, for example, on swap rates and fixing rates, e.g., if the tested instrument includes a swap instrument.

In some demonstrative embodiments, module 160 may provide the back-testing results in the form of a payoff graph of historical performance, e.g., depicting values of the evaluated payoff, e.g., expressed as a payoff percentage, versus the expiration date.

Additionally or alternatively, module 160 may provide the back-testing results including a comparison to a performance of the tested instrument, performance of the underlying asset, a zero level of the payoff (zero level), performance of individual options comprising the tested instrument, if applicable, and the like.

Additionally or alternatively, module 160 may provide the back-testing results including Yield Statistics (Stats), e.g., in the format of distribution and/or cumulative histograms, for example, of the return per annum of the tested instrument, e.g., in a bar chart format. For example, the back-testing results may include a histogram of the annual yield, for example, the annual rate of return on the tested instrument, e.g., expressed as a percentage. The histogram may include a bar chart representing a frequency distribution, for example, wherein each bar may represent the observed frequencies in a particular category. In one example, module 160 may provide at least a distribution histogram relating to the annual return and a cumulative histogram representing the cumulative annual return, e.g., from top to bottom. The yield may be presented with respect to a defined yield range, e.g., a yield below a given percentage, a yield between a range of percentages, a yield over a given percentage, and the like.

Additionally or alternatively, module 160 may provide the back-testing results including statistics of the payoff, e.g., minimum payoff (Min), maximum payoff (Max), average payoff, standard deviation of the payoff, and the like.

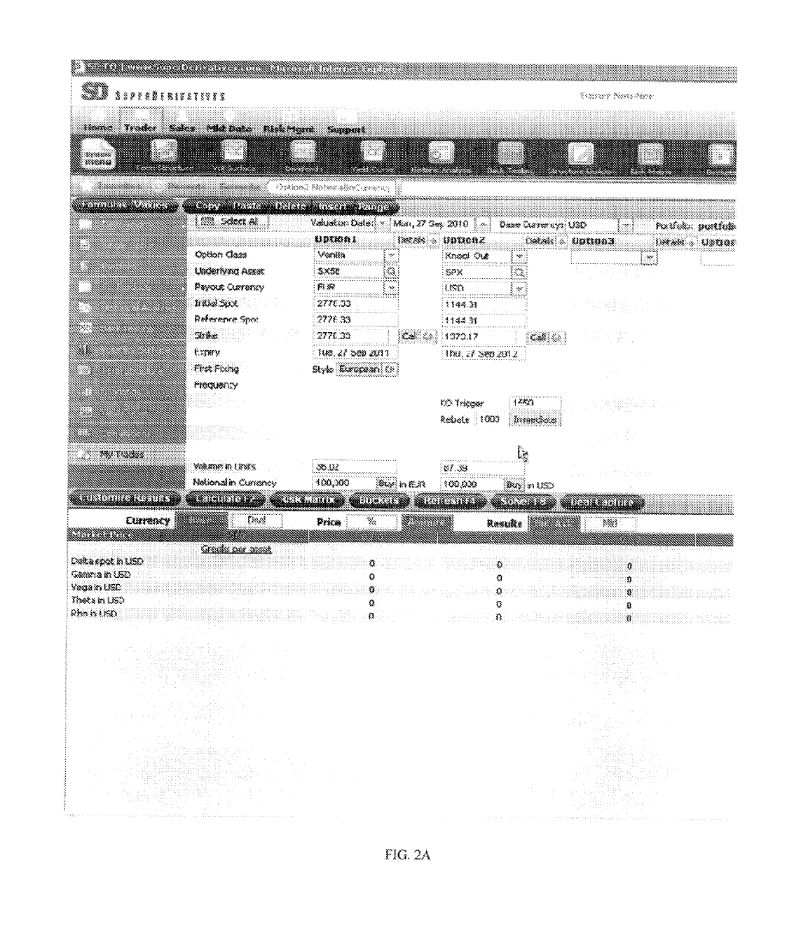

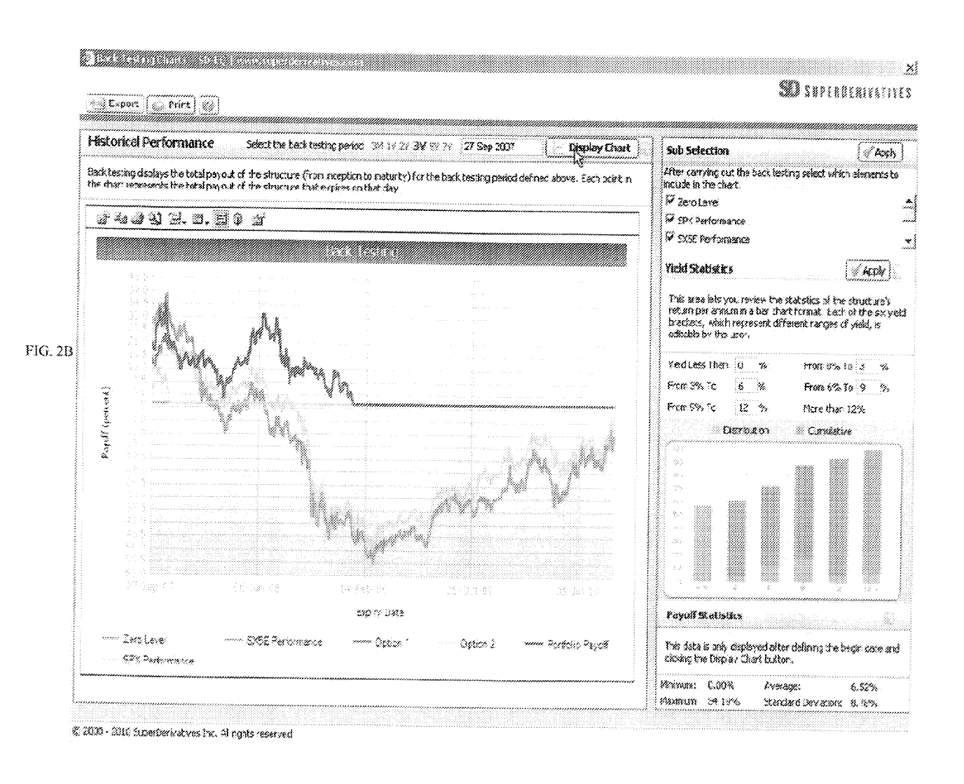

FIG. 2A depicts a screenshot illustration of a GUI for defining a FX instrument to be back-tested; and FIG. 2B depicts a screenshot illustration of back-testing results of back-testing the FX instrument of FIG. 2A according to the “Buy and hold total payout” scheme, in accordance with some demonstrative embodiments.

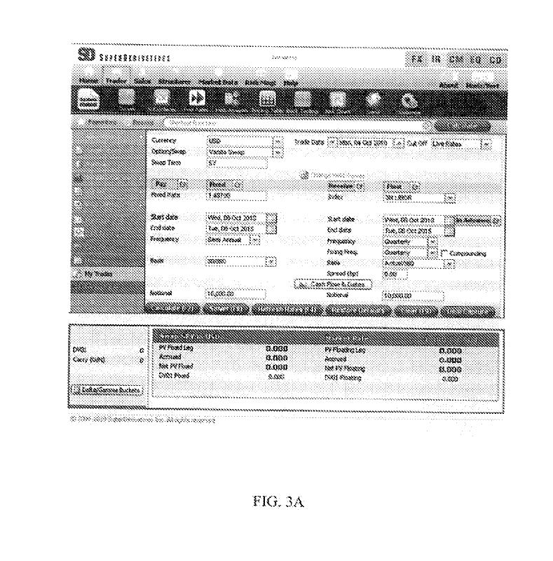

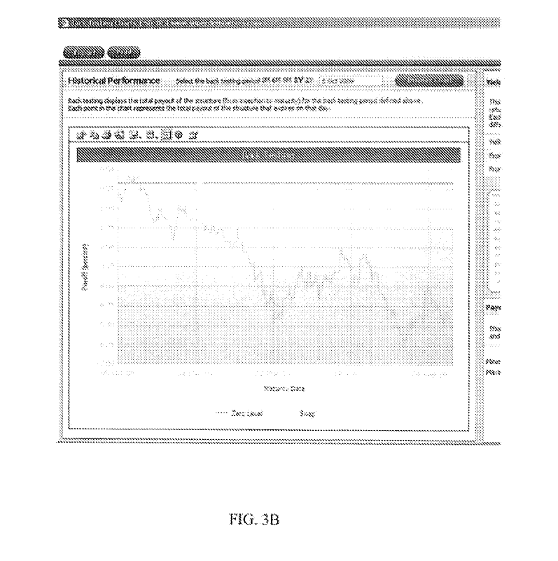

FIG. 3A depicts a screenshot illustration of a GUI for defining an IR instrument to be back-tested; and FIG. 3B depicts a screenshot illustration of back-testing results of back-testing the IR instrument of FIG. 3A according to the “Buy and hold total payout” scheme, in accordance with some demonstrative embodiments.

As shown in FIG. 3A, the tested IR instrument includes a strategy including a USD five year (5 Y) vanilla swap 100 mio, pay fix receive float. The back-test period is one year (1 Y). The current (Run) date is Aug. 20, 2010.

Module 160 may evaluate a series of scenarios, e.g., each corresponding to a respective day within the period of Aug. 20, 2009 and Aug. 20, 2010.

For example, module 160 may evaluate a first scenario including the pricing of a first Vanilla (Van) 5 Y swap (spot starting) having a maturity date of Aug. 20, 2009, i.e., having a trade date of Aug. 18, 2004, e.g., the current date minus the back testing period of one year, minus the swap tenor of five years.

Module 160 may determine the BE rate corresponding to the trade date of the first swap, e.g., as described above. For example, the BE rate corresponding to the trade date of the first swap may be determined to be 5%.

Module 160 may determine the total cash paid for the first swap, for example, by calculating the total coupon payments until maturity, e.g., using the BE rate of 5%.

Module 160 may determine the total cash received for the first swap, for example, by calculating the total coupons received until maturity, e.g., using a known fixing rate for each floating coupon.

Module 160 may determine the result of the first scenario to be equal to the difference between the total cash received and the total cash paid.

Module 160 may evaluate a second scenario including the pricing of a second Van 5 Y swap (spot starting) having a maturity date of Aug. 21, 2009, i.e., having a trade date of Aug. 19, 2004.

Module 160 may determine the BE rate corresponding to the trade date of the second swap, e.g., as described above. For example, the BE rate corresponding to the trade date of the second swap may be determined to be 5.25%.

Module 160 may determine the total cash paid for the second swap, for example, by calculating the total coupon payments until maturity, e.g., using the BE rate of 5.25%.

Module 160 may determine the total cash received for the second swap, for example, by calculating the total coupons received until maturity, e.g., using a known fixing rate for each floating coupon.

Module 160 may determine the result of the second scenario to be equal to the difference between the total cash received and the total cash paid.

Module 160 may determine results of additional scenarios, e.g., corresponding to respective additional swaps. For example, each additional swap may have a maturity date, which is one day later than a previous swap. For example, module 160 may evaluate the lest scenario including the pricing of a last Van 5 Y swap (spot starting) having a maturity date of Aug. 20, 2010, i.e., having a trade date of Aug. 18, 2005.

Module 160 may determine the BE rate corresponding to the trade date of the last swap, e.g., as described above. For example, the BE rate corresponding to the trade date of the last swap may be determined to be 5.25%.

Module 160 may determine the total cash paid for the last swap, for example, by calculating the total coupon payments until maturity, e.g., using the BE rate of 5.25%.

Module 160 may determine the total cash received for the last swap, for example, by calculating the total coupons received until maturity, e.g., using a known fixing rate for each floating coupon.

Module 160 may determine the result of the last scenario to be equal to the difference between the total cash received and the total cash paid.

Module 160 may generate the back-testing results including the results of the tested scenarios, e.g., in the form of the graph shown in FIG. 3B.

In some demonstrative embodiments, module 160 may generate the back-testing results according to a “Profit/loss from inception” scheme. According to this back-testing scheme, module 160 may evaluate a total profit/loss (p&l) generated by the tested instrument during a back-testing period beginning at an inception date in the back-testing period, and ending at the current date.

In some demonstrative embodiments, module 160 may determine the p&l of the tested instrument based on a difference between the market value of the tested instrument on a tested period between two dates, the “inception date” and “the current date”, and taking into account all cash paid and received during the tested period. For example, module 160 may determine the p&l of the tested instrument based on the net present value (NPV) at the inception date (NPVstart), the net present value at the current date (NPVend), and the intermediate cash flows, e.g., NPVend−NPVstart+intermediate cashflows.

In some demonstrative embodiments, module 160 may evaluate the p&l of the tested instrument based, for example, on complete market data for each trade date in the back-testing period and the configuration parameters of the financial instrument.

In some demonstrative embodiments, module 160 may provide the back-testing results in the form of a payoff graph of historical performance, e.g., depicting values of the p&l, e.g., expressed as a p&l percentage, versus the inception date.

Additionally or alternatively, module 160 may provide the back-testing results including a comparison to a performance of the underlying asset, zero level, performance of individual options comprising the tested instrument, if applicable, and the like.

Additionally or alternatively, module 160 may provide the back-testing results including Yield Statistics (Stats), for example, of the return per annum of the tested instrument, e.g., in a bar chart format.

Additionally or alternatively, module 160 may provide the back-testing results including statistics of the payoff, e.g., Min, Max, Average, standard deviation, and the like.

In some demonstrative embodiments, module 160 may generate back-testing output of back-testing the tested instrument according to a “Profit/loss after time X” scheme. According to this back-testing scheme, module 160 may evaluate a total p&l generated by the tested instrument during a back-testing horizon period, e.g., six months, for example, a period beginning at a first date (“trade date”) and ending at a second date, which succeeds the first date by the horizon period, i.e., second date=trade date+horizon period.

In some demonstrative embodiments, module 160 may determine the p&l of the tested instrument based on a difference between the market value of the tested instrument on a tested period between the first and second dates, and taking into account all cash paid and received during the tested period. For example, module 160 may determine the p&l of the tested instrument based on the net present value at the first date (NPVstart), the net present value at the second date (NPVend), and the intermediate cash flows, e.g., NPVend−NPVstart+intermediate cashflows.

In some demonstrative embodiments, module 160 may evaluate the p&l of the tested instrument based, for example, on complete market data for each trade date in the back-testing period and the configuration parameters of the financial instrument.

In some demonstrative embodiments, module 160 may provide the back-testing results in the form of a payoff graph of historical performance, e.g., depicting values of the p&l, e.g., expressed as a p&l percentage, versus the trade date.

Additionally or alternatively, module 160 may provide the back-testing results including a comparison to a performance of the underlying asset, zero level, performance of individual options comprising the tested instrument, if applicable, and the like.

Additionally or alternatively, module 160 may provide the back-testing results including Yield Statistics (Stats), for example, of the return per annum of the tested instrument, e.g., in a bar chart format.

Additionally or alternatively, module 160 may provide the back-testing results including statistics of the payoff, e.g., Min, Max, Average, standard deviation, and the like.

In one example, module 160 may back-test an instrument including a USD 5 Y vanilla swap 100 mio strategy. The back testing period may be one year. The horizon period may be three months (3 M). The current date may be Aug. 20, 2010.

Module 160 may evaluate a series of scenarios, e.g., each corresponding to a respective day within the period of Aug. 20, 2009 and Aug. 20, 2010.

For example, module 160 may evaluate a first scenario including the pricing of a first 5 Y Van swap (spot starting) having a trade date of Aug. 20, 2009, e.g., a trade date of the current date minus the back testing period of one year.

Module 160 may determine the BE rate corresponding to the trade date of the first swap, e.g., as described above. For example, the BE rate corresponding to the trade date of the first swap may be determined to be 2.84%.

Module 160 may determine the NPV of the first swap at the trade date, e.g., NPV(start)=0.

Module 160 may determine the NPV of the first swap at a second date succeeding the trade date by the horizon period, e.g., at the date of Nov. 20, 2009. For example, module 160 may determine NPV(end)=−2.5mio.

Module 160 may determine the result of the first scenario based on the determined NPVs, e.g., by adding to the difference between NPVend and NPVstart, the cash from any coupon paid or received during the period between Aug. 20, 2009 and Nov. 20, 2009.

Module 160 may evaluate a second scenario including the pricing of a second 5 Y Van swap (spot starting) having a trade date of Aug. 21, 2009, e.g., a trade date succeeding the trade date of the first swap by one day.

Module 160 may determine the BE rate corresponding to the trade date of the second swap, e.g., as described above. For example, the BE rate corresponding to the trade date of the second swap may be determined to be 3.0%.

Module 160 may determine the NPV of the second swap at the trade date, e.g., NPV(start)=0.

Module 160 may determine the NPV of the second swap at a second date succeeding the trade date by the horizon period, e.g., at the date of Nov. 21, 2009. For example, module 160 may determine NPV(end)=−3.3mio.

Module 160 may determine the result of the second scenario based on the determined NPVs, e.g., by adding to the difference between NPVend and NPVstart, the cash from any coupon paid or received during the period between Aug. 21, 2009 and Nov. 21, 2009.

Module 160 may determine results of additional scenarios, e.g., corresponding to respective additional swaps, e.g., each having a trade date, which is one day later than a previous swap, for example, until a last scenario corresponding to a swap having a trade date, which is the horizon period prior to the current date, e.g., a trade date of Jun. 20, 2010.

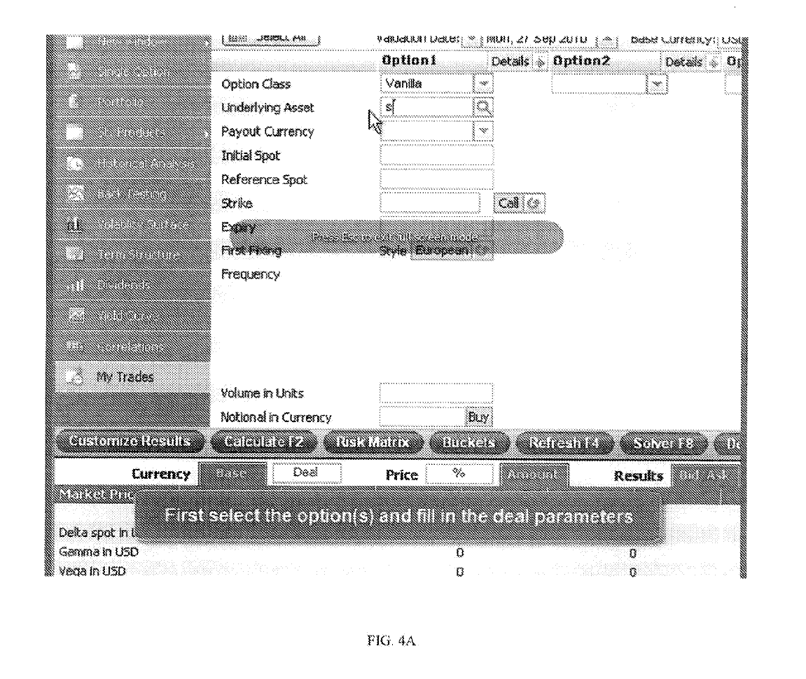

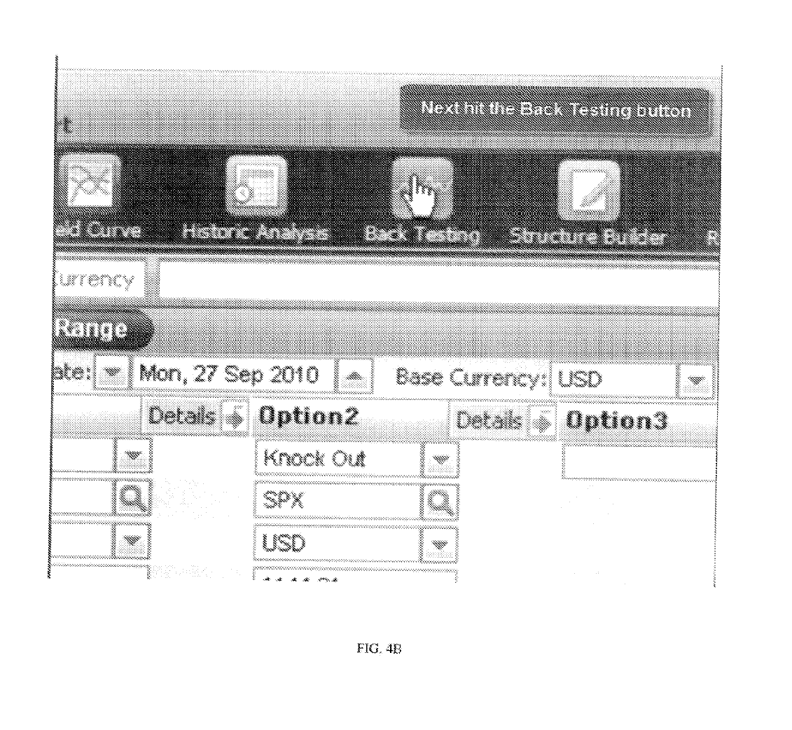

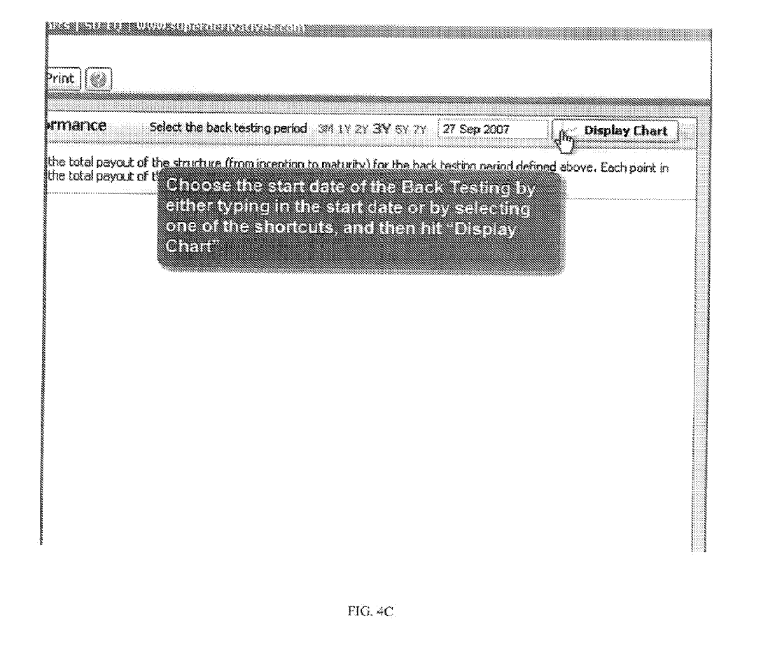

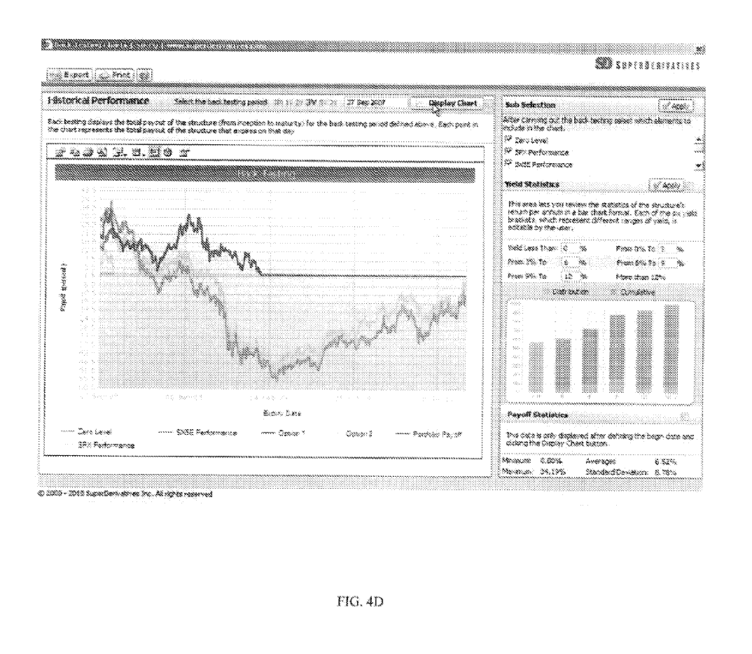

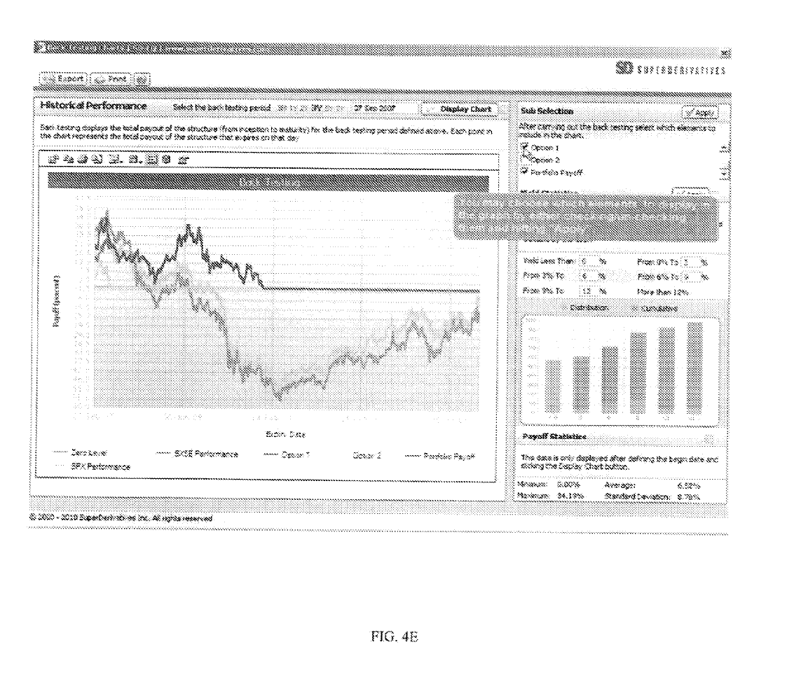

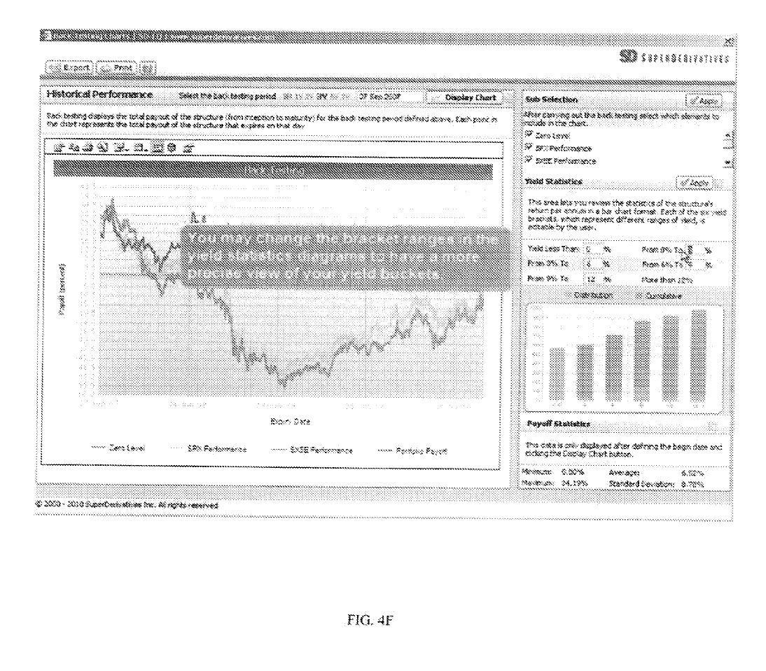

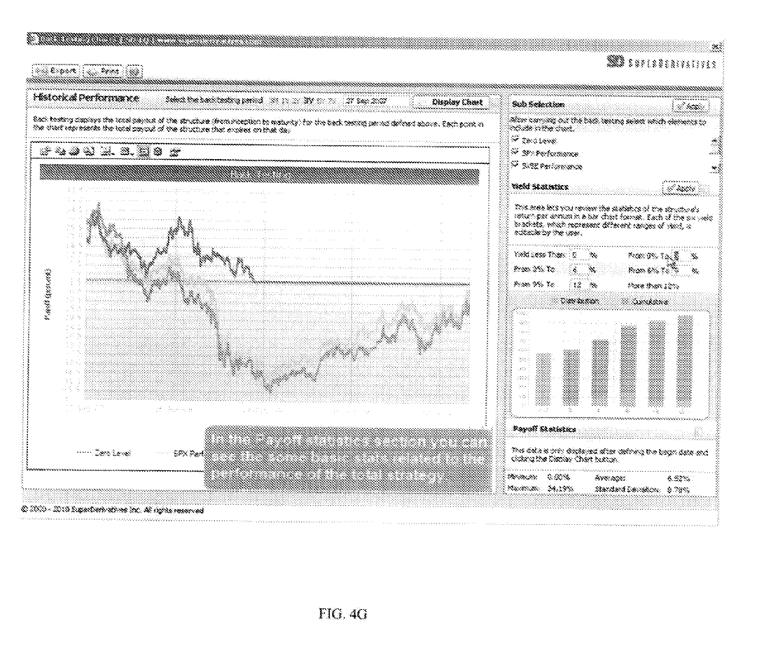

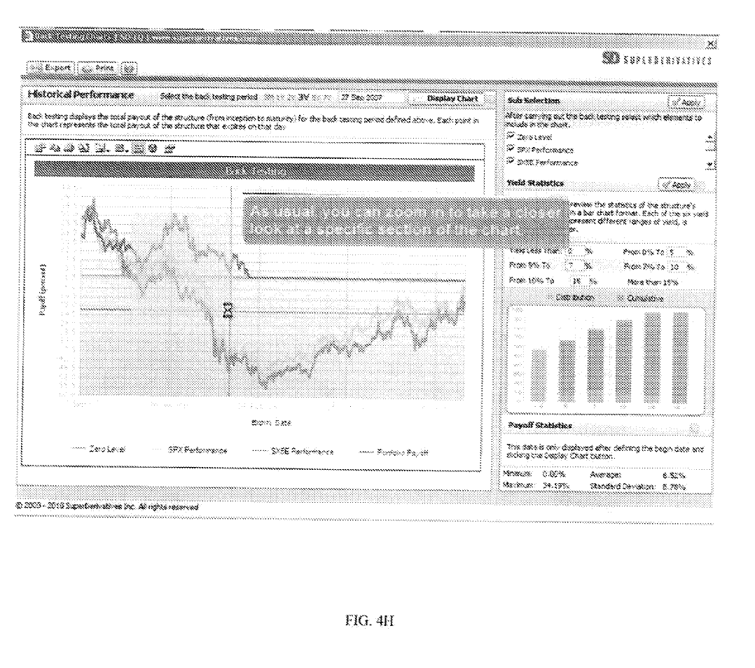

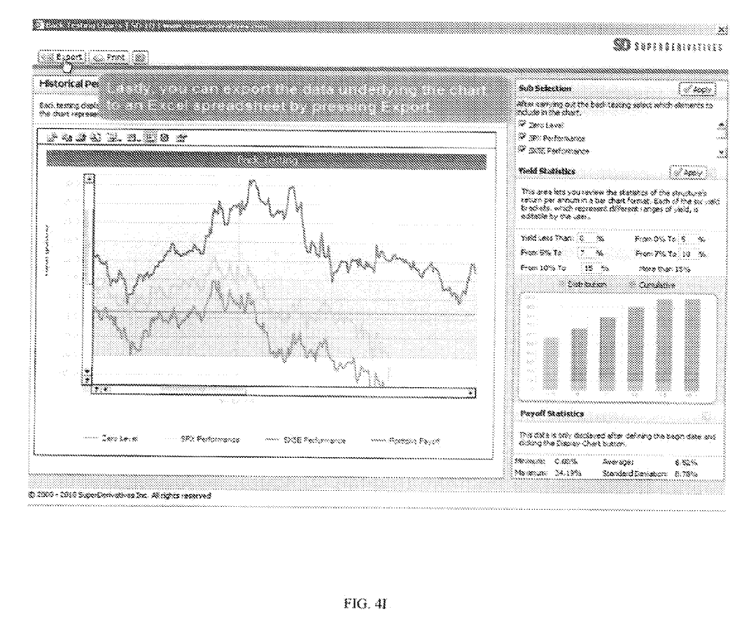

FIGS. 4A-4J depict a series of screenshot illustrations of a series of operations for performing back-testing of a financial instrument, in accordance with some demonstrative embodiments.

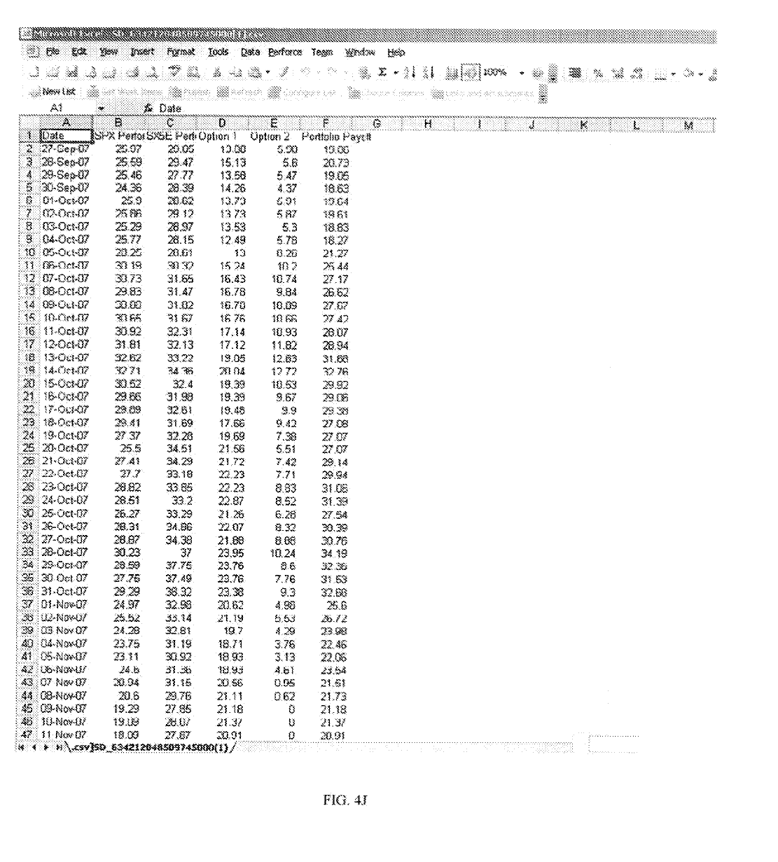

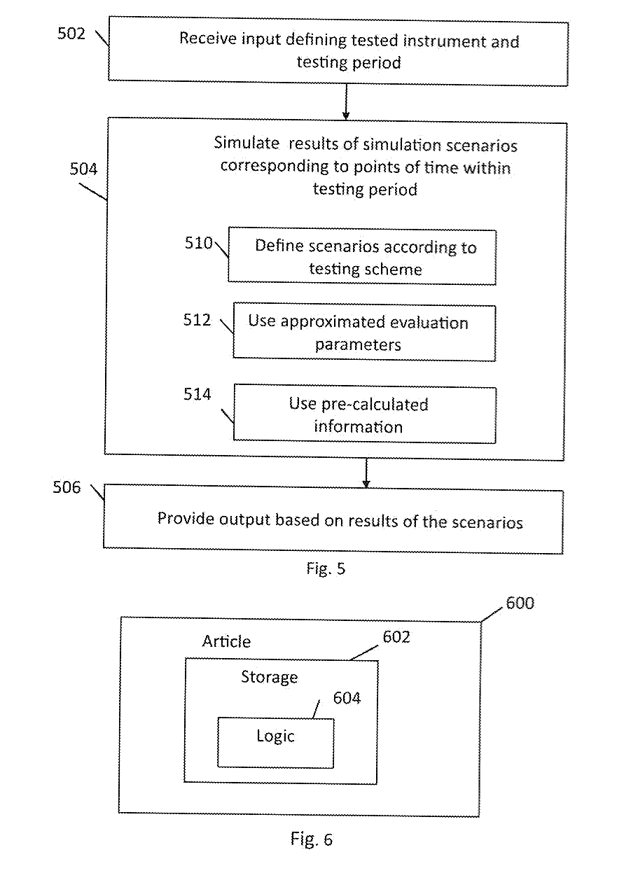

Reference is made to FIG. 5, which schematically illustrates a method of testing a financial instrument, in accordance with some demonstrative embodiments. In some embodiments, one or more operations of the method of FIG. 5 may be preformed by a computing device or system, e.g., computing system 183 (FIG. 1), a processor, e.g., processor 185 (FIG. 1), an analysis module, e.g., module 160 (FIG. 1), and/or any other suitable, device, system or module.

As indicated at block 502, the method may include receiving input information defining a tested financial derivative instrument and one or more testing parameters defining at least a testing period. For example, module 160 (FIG. 1) may receive from a user, e.g., via interface 110 (FIG. 1), input information defining a tested financial derivative instrument and one or more testing parameters defining at least a testing period, e.g., as described above.

In some demonstrative embodiments, the points of time may include at least one of an expiration date of the simulated financial derivative instrument, a trade date of the simulated financial derivative instrument and an inception date of the simulated financial derivative instrument, e.g., as described above.

As indicated at block 504, the method may include simulating results of a plurality of simulation scenarios corresponding to a plurality of points of time within the testing period. For example, module 160 (FIG. 1) may simulate results of a plurality of simulation scenarios, wherein, for example, each scenario includes a modification of the tested financial derivative instrument with respect to a point of time within the testing period, e.g., as described above.

In some demonstrative embodiments, a simulation scenario of the plurality of simulation scenarios, which corresponds to a point of time of the plurality of points of time, may include a simulation of a modified replica of the tested financial derivative instrument with respect to the point of time, e.g., as described above.

In some demonstrative embodiments, the plurality of points of time within the testing period may include a plurality of historic points of time preceding a current time of testing the tested financial derivative instrument. For example, module 160 (FIG. 1) may simulate the results of the plurality of simulation scenarios by determining the results of the plurality of simulation scenarios based on historical market data corresponding to the plurality of historic points of time, e.g., as described above.

As indicated at block 510, the input information may define a testing scheme, and simulating the results of the plurality of simulation scenarios may include defining the plurality of simulation scenarios according to the testing scheme. For example, module 160 (FIG. 1) may define the simulation scenarios according to a buy and hold total payoff scheme, a profit/loss from inception scheme, a profit/loss during a time period of a predefined length, and/or any other scheme, e.g., as described above.

As indicated at block 512, simulating the results of the plurality of simulation scenarios may include simulating the results of the plurality of simulation scenarios based on one or more approximated evaluation parameters corresponding to the plurality of points of time within the testing period. For example, module 160 (FIG. 1) may calculate an approximation of one or more evaluation parameters relating to the tested financial instrument, e.g., as described above.

As indicated at block 514, simulating the results of the plurality of simulation scenarios may include simulating the results of the plurality of simulation scenarios based on pre-calculated information, for example, including one or more pre-calculated volatility surfaces and/or yield curves corresponding to one or more of the plurality of points of time within the testing period. For example, module 160 (FIG. 1) may utilize pre-calculated information 163 (FIG. 1), e.g., as described above.

As indicated at block 506, the method may include providing an output, which is based on the results of the plurality of scenarios. For example, module 160 (FIG. 1) may provide an output, for example, a graphical, textual and/or numerical output representing the results of the simulated scenarios, e.g., as described above.

Reference is made to FIG. 6, which schematically illustrates an article of manufacture 600, in accordance with some demonstrative embodiments. Article 600 may include a machine-readable storage medium 602 to store logic 604, which may be used, for example, to perform at least part of the functionality of module 160 (FIG. 1) and/or interface 110 (FIG. 1); to perform one or more operations of the method of FIG. 5; and/or to perform one or more operations described herein.

In some demonstrative embodiments, article 600 and/or machine-readable storage medium 602 may include one or more types of computer-readable storage media capable of storing data, including volatile memory, non-volatile memory, removable or non-removable memory, erasable or non-erasable memory, writeable or re-writeable memory, and the like. For example, machine-readable storage medium 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, some embodiments are not described with reference to any particular programming language. It will be appreciated that a variety of programming languages may be used to implement the teachings of the invention as described herein.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. (canceled)

2. A system comprising:
a database to store pre-calculated information corresponding to a plurality of historical points in time, the pre-calculated information corresponding to a historical point of time comprising at least one type of information selected from a group consisting of a pre-calculated volatility surface corresponding to said historical point of time, and a pre-calculated yield curve corresponding to said historical point of time;
an interface to receive input information comprising a plurality of financial instrument parameters defining a financial derivative instrument to be tested and one or more testing parameters defining at least a testing scheme with respect to a tested period; and
a processor configured to process said input information and to determine a plurality of back-tested time points within a back-testing period based on the tested period, said processor configured to define a plurality of simulated scenarios corresponding to said plurality of back-tested time points based on the testing scheme, the processor to define a simulated scenario corresponding to a back-tested time point based on the testing scheme and a simulated financial derivative instrument, the simulated financial derivative instrument is based on the plurality of financial instrument parameters and the back-tested time point, said processor is configured to determine a plurality of simulation results of the plurality of simulated scenarios corresponding to said plurality of back-tested time points, said processor is configured to selectively retrieve from said database pre-calculated information corresponding to the back-tested time point, and to determine a simulation result of the simulated scenario corresponding to said back-tested time point based on the pre-calculated information corresponding to the back-tested time point, said processor to cause the interface to provide an output based on the plurality of simulation results.

3. The system of claim 2, wherein said processor is configured to define the simulated scenario corresponding to the back-tested time point with respect to a simulated financial derivative instrument having either an expiration date or an inception date at said back-tested time point.

4. The system of claim 3, wherein the plurality of simulated scenarios include a respective plurality of simulated financial derivative instruments, the plurality of simulated financial derivative instruments having expiration dates at respective ones of the plurality of back-tested time points.

5. The system of claim 3, wherein the plurality of simulated scenarios include a respective plurality of simulated financial derivative instruments, the plurality of simulated financial derivative instruments having inception dates at respective ones of the plurality of back-tested time points.

6. The system of claim 2, wherein said testing scheme comprises a buy and hold total payoff scheme, said processor to determine the simulation result corresponding to said back-tested time point by determining a total payout of a simulated financial derivative instrument, which is defined based on the plurality of financial instrument parameters and has an expiration date at said back-tested time point.

7. The system of claim 6, wherein the processor is configured to determine the simulation result based on a sum of one or more coupon payments on said simulated financial derivative instrument according to the simulated scenario corresponding to said back-tested time point.

8. The system of claim 2, wherein said testing scheme comprises a profit/loss from inception scheme, said processor to determine the simulation result corresponding to said back-tested time point by determining a total profit or loss of a simulated financial derivative instrument, which is defined based on the plurality of financial instrument parameters and has an inception date at said back-tested time point and an expiration date at a current date.

9. The system of claim 8, wherein the processor is configured to determine the simulation result based on a difference between a market value of the simulated financial derivative instrument at the current date and a market value of the simulated financial derivative instrument at the back-tested time point, and based on a sum of one or more coupon payments on said simulated financial derivative instrument between the back-tested time point and the current date.

10. The system of claim 2, wherein said testing scheme comprises a profit/loss during a time period of a predefined length, said processor to determine the simulation result corresponding to said back-tested time point by a total profit or loss of a simulated financial derivative instrument, which is defined based on the plurality of financial instrument parameters, during a time period beginning at said back-tested time point and having said predefined length.

11. The system of claim 10, wherein the processor is configured to determine the simulation result based on a difference between a market value of the simulated financial derivative instrument at an end date and a market value of the simulated financial derivative instrument at the back-tested time point, and based on a sum of one or more coupon payments on said simulated financial derivative instrument between the back-tested time point date and the end date, the end date is separated from the back-tested time point by the time period of the predefined length.

12. The system of claim 2, wherein said processor is to determine the simulation result corresponding to said back-tested time point based on historical market data corresponding to the simulated financial derivative instrument.

13. The system of claim 2, wherein said processor is to determine the simulation result corresponding to said back-tested time point based on one or more approximated evaluation parameters corresponding to said back-tested time point.

14. The system of claim 2, wherein said processor is configured to forward-test said financial derivative instrument to predict a future performance of said financial derivative instrument based on the plurality of simulation results.

15. The system of claim 2, wherein the implied volatility surface corresponding to the historical point of time comprises an implied volatility corresponding to the historical point of time as a function of both a strike price and a time to maturity.

16. The system of claim 2, wherein said interface is configured to receive market data corresponding to the financial derivative instrument.

17. A non-transitory machine-readable medium having stored thereon instructions, which when executed by a machine, result in:
storing in a database pre-calculated information corresponding to a plurality of historical points in time, the pre-calculated information corresponding to a historical point of time comprising at least one type of information selected from a group consisting of a pre-calculated volatility surface corresponding to said historical point of time, and a pre-calculated yield curve corresponding to said historical point of time;
processing input information comprising a plurality of financial instrument parameters defining a financial derivative instrument to be tested and one or more testing parameters defining at least a testing scheme with respect to a tested period, processing the input information comprises:
determining a plurality of back-tested time points within a back-testing period based on the tested period;
defining a plurality of simulated scenarios corresponding to said plurality of back-tested time points based on the testing scheme, defining the plurality of simulated scenarios comprising defining a simulated scenario corresponding to a back-tested time point based on the testing scheme and a simulated financial derivative instrument, the simulated financial derivative instrument is based on the plurality of financial instrument parameters and the back-tested time point;
determining a plurality of simulation results of the plurality of simulated scenarios corresponding to said plurality of back-tested time points, determining the plurality of simulation results comprising selectively retrieving from said database pre-calculated information corresponding to the back-tested time point, and determining a simulation result of the simulated scenario corresponding to said back-tested time point based on the pre-calculated information corresponding to the back-tested time point; and
causing an interface to provide an output based on the plurality of simulation results.

18. The non-transitory machine-readable medium of claim 17, wherein the instructions, when executed, result in defining the simulated scenario corresponding to the back-tested time point with respect to a simulated financial derivative instrument having either an expiration date or an inception date at said back-tested time point.

19. The non-transitory machine-readable medium of claim 17, wherein said testing scheme comprises a buy and hold total payoff scheme, said instructions, when executed, result in determining the simulation result corresponding to said back-tested time point by determining a total payout of a simulated financial derivative instrument, which is defined based on the plurality of financial instrument parameters and has an expiration date at said back-tested time point.

20. The non-transitory machine-readable medium of claim 17, wherein said testing scheme comprises a profit/loss from inception scheme, said instructions, when executed, result in determining the simulation result corresponding to said back-tested time point by determining a total profit or loss of a simulated financial derivative instrument, which is defined based on the plurality of financial instrument parameters and has an inception date at said back-tested time point and an expiration date at a current date.

21. The non-transitory machine-readable medium of claim 17, wherein said testing scheme comprises a profit/loss during a time period of a predefined length, said instructions, when executed, result in determining the simulation result corresponding to said back-tested time point by a total profit or loss of a simulated financial derivative instrument, which is defined based on the plurality of financial instrument parameters, during a time period beginning at said back-tested time point and having said predefined length.
